(19) United States
(12) Patent Application Publication
(10) Pub. No.: US 2012/0234821 A1
(43) Pub. Date: Sep. 20, 2012

(54) Non-Combustion Smoking Tool

(76) Inventor: Kazuhiko Shimizu, Kobe-shi (JP)

(21) Appl. No.: 13/513,412

(22) PCT Filed: Nov. 4, 2010
(86) PCT No.: PCT/JP2010/070151

§ 371 Date: Jun. 1, 2012

(30) Foreign Application Priority Data
Dec. 4, 2009 (JP) 2009-293338

(51) Int. Cl. H05B 3/02

(52) U.S. Cl. 219/227

(57) ABSTRACT

A non-combustion smoking tool is usable with a commercial cigarette or cigar as it is, the tool vaporizes nicotine from the tobacco leaves and enables inhalation of the vaporized nicotine without burning the product. The non-combustion smoking tool has a heater to be used which includes a coil part and a linear part to be inserted into a commercial cigarette or cigar, wherein the linear part preheats the tobacco leaves, and the coil part heats air around the coil part so that, when a smoker inhales, the heated air around the coil part passes through the tobacco leaves so as to vaporize nicotine contained in the tobacco leaves and enable inhalation of the vaporized nicotine.

### TECHNICAL FIELD

The present invention relates to an improvement over the non-combustion smoking tool of Japanese Patent Application No. 2009-049879 (having U.S. counterpart patent application Ser. No. 13/147,694) made by the present applicant (which will be referred to as “tool of the earlier application of the present application”), and the document of the earlier application is quoted in its entirety in the present application.

### BACKGROUND ART

The “tool of the earlier application of the present application” has been proposed to improve various problems of a normal smoking method to light tobacco leaves for smoking, and a tool has been devised which, while using a generally commercial cigarette or cigar as it is, can vaporize nicotine from the tobacco leaves at a suitable temperature to enable inhalation without burning the tobacco leaves, making it possible to inhale nicotine.

### PRIOR ART DOCUMENT(S)

### Patent Document(s)

Patent Document 1: Japanese Patent Application No. 2009-049879

### SUMMARY OF THE INVENTION

### Problem(s) to be Solved by the Invention

However, when the “tool of the earlier application of the present application” was actually used, the following problems were found.
Control of the heating temperature of a heater is difficult, and moreover requires some synchronization with inhalation by a smoker when actually smoking.
Further, in order to make it possible to carry and use the tool anywhere, a battery or a rechargeable battery needs to be used as a power supply. However, it requires addition of improvements to a driving circuit or a driving waveform for heating the heater, because otherwise the power consumption would be too high, causing a very short use time if a battery or a rechargeable battery is used.
Further, when a filter cigarette is inserted into the tool for use, nicotine is vaporized by heating the tobacco leaves with the heater. However, when inhaled through the filter, the nicotine once generated by the heat is absorbed by the filter, so that the smoker cannot sufficiently inhale the vaporized nicotine.
Further, when a filter cigarette is inserted into the tool for use, water contained in the tobacco leaves is vaporized by heating the tobacco leaves with the heater, and is condensed by the filter, thereby wetting the filter and increasing the absorption of nicotine by the filter, so that the smoker cannot sufficiently inhale the vaporized nicotine.

### Means to Solve the Problem(s)

In order to solve the problems of the “tool of the earlier application of the present application” described above, the present invention has devised a heater having a novel structure, and has adopted it as a heater to heat tobacco leaves. The novel heater comprises a linear part and a coil part, and enables synchronization with inhalation of a user. The adoption of the novel heater has made it easier to use and control temperature of the non-combustion smoking tool of the present invention.

Further, by devising a control circuit to heat the heater, it has become possible to vaporize and inhale nicotine contained in the tobacco leaves effectively with lower power than before.

In addition, an improvement in an outside air inlet of the tool according to the present invention has allowed a mouthpiece to be inserted into the outside air inlet so as to enable smoking from the end opposite to where the cigarette is inserted.

### Effect of the Invention

FIG. 5 shows a structure of the heater having a novel structure adopted in the present invention. The heater having the novel structure is a heater comprising a linear part and a coil part, in which the linear part of the heater is inserted into a cigarette or a cigar, and is used only to preheat the leaves of the cigarette or the cigar. The coil part of the heater heats air around the coil part. (The heated air will be hereafter referred to as “hot air”.) The “hot air” passes through the cigarette or the cigar when a smoker inhales. Thus, it has an advantage that nicotine can be effectively vaporized from the cigarette or the cigar with the insertion.

Further, it has an advantage that when a current is applied to the heater having the novel structure adopted in the present invention, the surface temperature of the coil part of the heater rises by 70° C. or more than the linear part, allowing the surface temperature of the heater at the coil part to rise with a smaller current value than a heater having only a linear part, thus making it possible to use this tool with a battery or a rechargeable battery for a long time.

Further, the present invention has an advantage that the study of the control circuit allows reduction in power consumed by the circuit itself and reduction in size of components forming the circuit, making it possible to drive this tool with a battery or a rechargeable battery, and to reduce the size of the tool itself due to the reduction of the size of the circuit section.

Further, the present invention has an advantage that the power supplied to the heater can be controlled by the smoker, making it possible to smoke at a temperature desired by the smoker.

Further, the present invention has an advantage that, upon inhalation, the smoker can increase or decrease the power supplied to the heater from a power which the smoker predetermine.

Further, according to the “tool of the earlier application of the present application”, the tobacco leaves are continuously heated to cause a large amount of vaporization of water vapor from the tobacco leaves, which is condensed by the filter. This causes the problem that nicotine once generated by the heat is absorbed by the filter wetted with water, so that the smoker takes only a small amount of nicotine into mouth. However, the present invention has an advantage that the heating at the linear part is preheating, so that the vaporization of water vapor is reduced, preventing the filter from being wetted.

Further, when the “tool of the earlier application of the present application” is used for smoking, hot air may enter the mouth of the inhaler if the heater temperature is set at a relatively high level. However, the present invention also has an advantage that the “hot air” is taken in only upon inhalation and along with outside air at the same time, preventing the inhaler from feeling hot.

### BRIEF DESCRIPTION OF THE DRAWING(S)

FIG. 1 is an outline view of a non-combustion smoking tool of the present embodiment.

FIG. 2 is an outline view of another non-combustion smoking tool of the present embodiment.

FIG. 3 is an axial cross-sectional view of FIG. 1.

FIG. 4 is an axial cross-sectional view of FIG. 2.

FIG. 5 is an outline view of a heater having a novel structure adopted in the tool of the present application.

FIG. 6 is an outline view of a mouthpiece which is attached for use to the tool of the present application.

FIG. 7 is an example of an improved circuit diagram used in the tool of the present application.

FIG. 8 is an example of an improved waveform of applied voltage used in the tool of the present application.

FIG. 9 is a cross-sectional view of a tool formed by improving an outside air inlet of the “tool of the earlier application of the present application”.

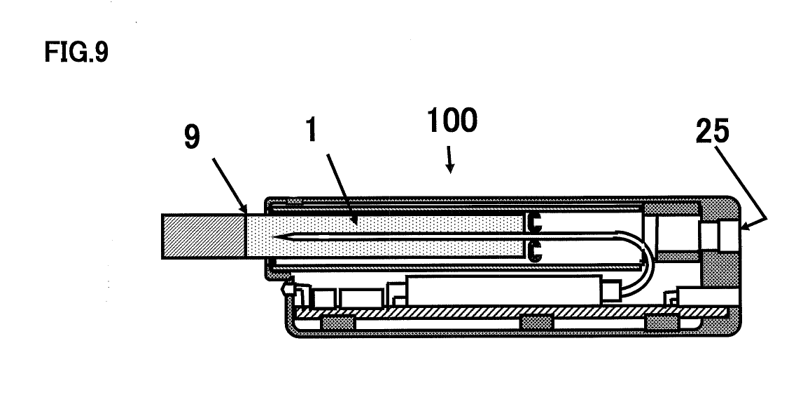

### DESCRIPTION OF THE EMBODIMENTS

Hereinafter, detailed description will be made with reference to the drawings, giving a filter cigarette as an example of commercial cigarettes and cigars for the present invention. However, it is needless to say that the tool of the present invention can also be used for commercial plain cigarettes, cigars and the like, other than filter cigarettes.

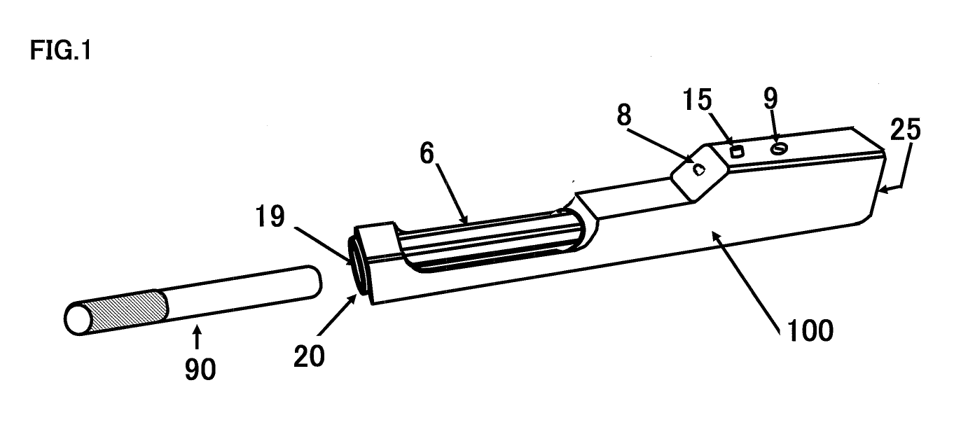

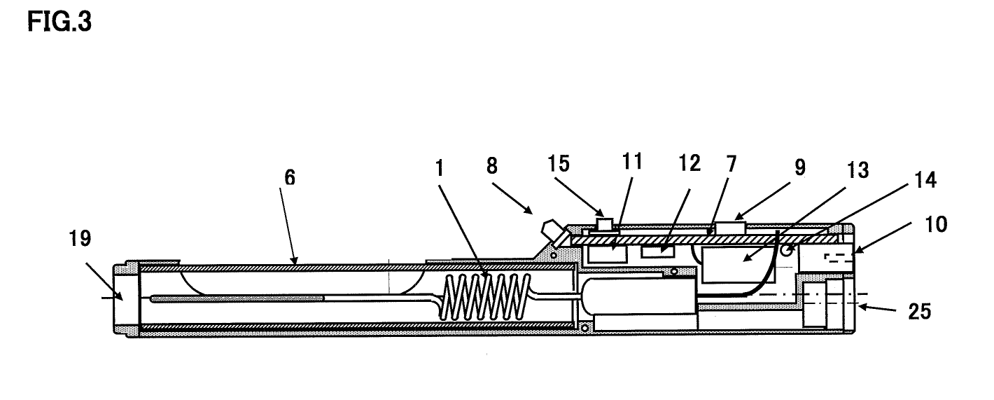

FIG. 1 shows appearance of an example of a tool according to the present invention. A tool 100 is composed of inner structural components comprising: a tobacco insertion opening 19 formed in a projection 20 for inserting a filter cigarette 90; an indicator 8 for indicating operation states; a Volume 9 for regulating power supplied to a heater 1; a Switch 15 for allowing a smoker to regulate power supplied to the heater 1 while smoking; a connector 10 (shown in FIG. 3) for receiving power from outside; an outside air inlet 25 (shown in FIG. 3); a thermal insulation material (glass pipe, ceramic pipe) 6; a component-embedded printed circuit board 7 (shown in FIG. 3); and a heater 1 (shown in FIG. 3).

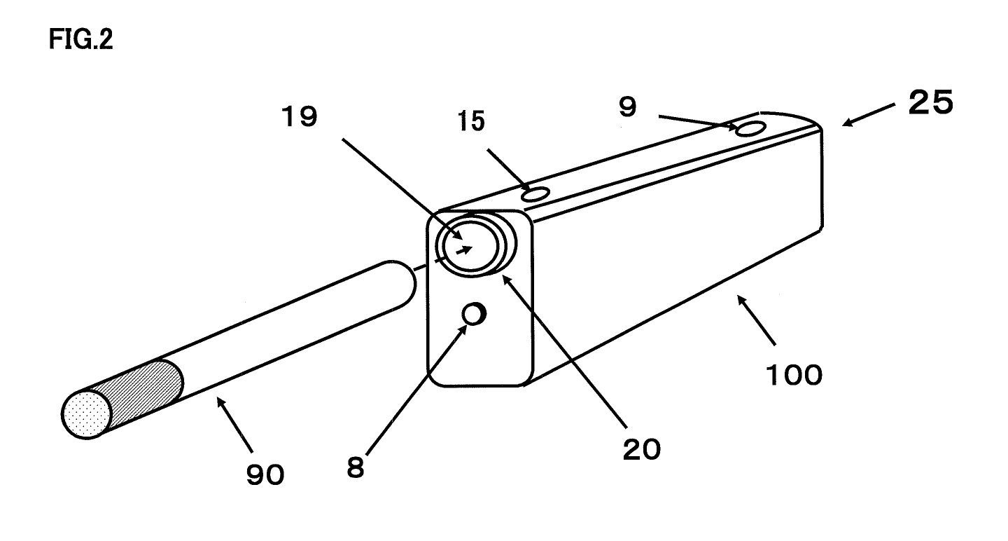

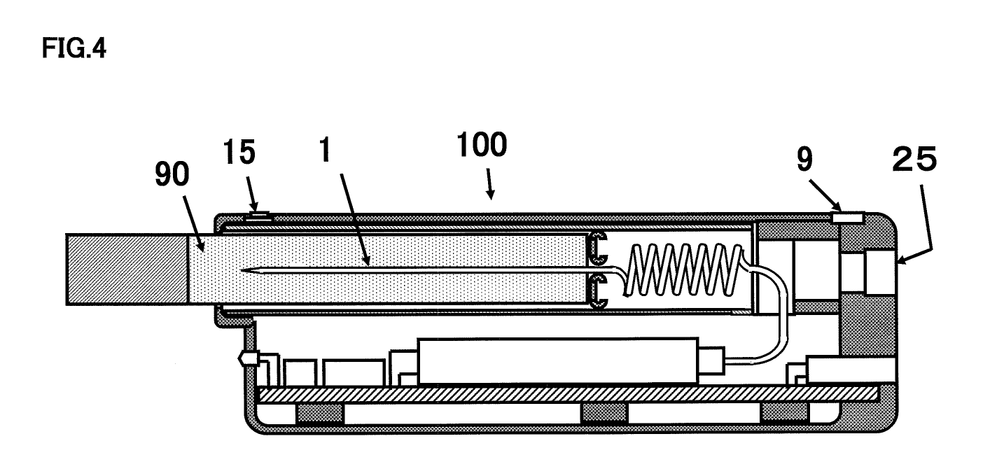

FIG. 2 shows appearance of another example of a tool according to the present invention. A tool 100 is one formed by adding improvements to the “tool of the earlier application of the present application”, which has a heater 1 deformed in U-shape and mounted therein, and additionally comprises an outside air inlet 25 (shown in FIG. 4), a Volume 9 and a Switch 15.

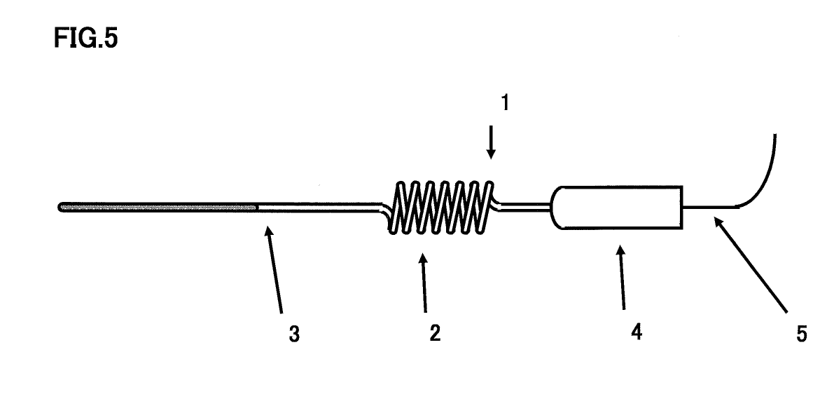

FIG. 5 is an appearance view of the heater 1 having a novel structure used in the tool according to the present invention. The heater 1 uses what is normally referred to as a micro-sheath heater, but it is needless to say that the heater structure, in particular, is not limited if it is a slender rod-shaped heater which can be inserted into a filter cigarette. The heater having the novel structure used in the tool according to the present invention will be described. The heater 1 shown in FIG. 5 comprises four parts, those are linear part 3 having a sharp or round end inserted into the cigarette, a coil part 2, a sleeve 4 to connect a resistance wire to a lead part, and the lead part 5 for receiving power supplied from outside. The inside of the linear part does not have a resistance wire (heating wire=nichrome wire) over the entire length thereof, and, for example, has no resistance wire in the hatched area shown in FIG. 5.

FIG. 3 and FIG. 4 are axial cross-sectional views of the non-combustion smoking tools according to the present invention as shown in FIG. 1 and FIG. 2, in which 6 is a thermal insulation material (glass pipe, ceramic pipe), 7 is a printed circuit board with a built-in circuit capable of regulating power supplied to the heater 1 from outside, 8 is an indicator for indicating operation states, 9 is a Volume for regulating power supplied to the heater 1, 10 is a connector for receiving power from outside, 11 is an output Transistor, 12 is a CPU, 13 is an electrolytic capacitor, 14 is a fuse, 15 is a Switch for allowing a smoker to regulate power supplied to the heater 1 while smoking, 19 is a tobacco insertion opening, and 25 is an outside air inlet.

The outside air inlet 25 shown in FIG. 3 and FIG. 4 normally has a cotton or a filter inserted therein to have a function to remove dust and the like in the air taken in when the smoker inhales.

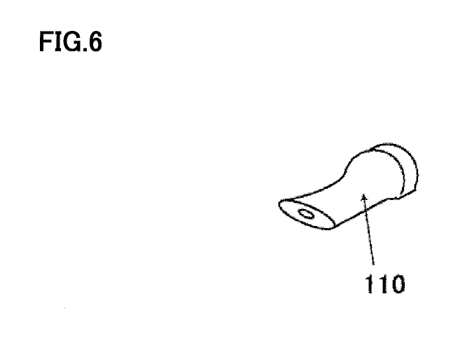

However, the outside air inlet 25 can have another important function. When a mouthpiece 110 (shown in FIG. 6), which is suitable to fit into the outside air inlet 25, is inserted into the outside air inlet 25, it becomes possible for the smoker to smoke from the end opposite to where the cigarette is inserted, so that nicotine vaporized from the tobacco leaves can be directly and sufficiently inhaled without absorption by the filter of the inserted cigarette. In addition, in this case, it is evident that the filter attached to the inserted cigarette has a function to remove dust and the like in the air taken in.

Now, another way of using the mouthpiece 110 shown in FIG. 6 will be described. The following describes a method of smoking using the mouthpiece 110 shown in FIG. 6 in the tool 100 of the present invention as shown in FIG. 1 and FIG. 2. It is a case where a filterless and so-called plain cigarette is used, or a case where the present tool is used by removing the filter portion of a filter cigarette. In this case, in order to vaporize nicotine over the entire length of the cigarette, it is required to insert the entire length of the cigarette into the present tool, thereby causing its mouth end to be lost. The mouthpiece 110 is thus inserted into the projection 20 of the present tool so as to secure the mouth end and allow comfortable smoking.

Next, the heater 1 will be described in detail below, in which the novel heater 1 adopted in the present invention has a coil part 4 and a linear part 3 having a sharp or round end designed to be insertable into a cigarette.

When the “tool of the earlier application of the present application” was actually used, the following difficulties in use were found.

1) The tobacco leaves vaporize nicotine while power is supplied to the heater. Thus, even if it is left without being inhaled, nicotine is vaporized, so that nicotine is lost only by leaving it without inhalation.

2) One way to improve this problem can be to detect inhalation so as to apply current to the heater. However, the temperature of the tobacco leaves does not rise immediately after the current application, so that nicotine does not come out unless it is inhaled for a pretty long time.

3) In the case of a method of applying a constant voltage to the heater, it is very difficult to control the applied voltage in that if the voltage is low, it takes a long time until nicotine is vaporized, while if the voltage is high, nicotine comes out immediately and completely.

As a means of improving such difficulties in using the “tool of the earlier application of the present application”, a non-combustion smoking tool which is convenient to use has been developed by providing a coil part in the heater section.

FIG. 5 shows a shape of the heater 1 having a novel structure comprising a linear part and a coil part, and the present inventor made prototypes of the heater 1 with the coil part, in which the lengths of the hatched area of the linear part (area having no resistance wire) were 10%, 50% and 90% of the linear part, and measured applied voltages and peak surface temperatures of the linear part 3 and the coil part 2. The following shows parameters of the heater with the coil of the prototypes that were then made:
1.6Φ Micro-sheath heater
Resistance wire 150 Ω/m
Length of linear part 3=55 mm,
Temperature measurement point: 15 mm from end
Length of coil part 2=20 mm, 5 Turns, Coil outer diameter=8Φ,
Temperature measurement point: center of coil part
Consequently, the results of the experiments as shown in Table 1 to Table 3 were obtained.

TABLE 1
Heater having resistance wire in 90% of linear part 3 (3-1)

| Applied | Peak Temperature of | Peak Temperature of | Temperature |
|---|---|---|---|
| Voltage | Linear Part 3 | Coil Part 2 | Difference |
| 12 V | 150° C. | 300° C. | 150° C. |
| 10 V | 110° C. | 225° C. | 115° C. |
| 8 V | 70° C. | 140° C. | 70° C. |

TABLE 2
Heater having resistance wire in 50% of linear part 3 (3-2)

| Applied | Peak Temperature of | Peak Temperature of | Temperature |
|---|---|---|---|
| Voltage | Linear Part 3 | Coil Part 2 | Difference |
| 12 V | 125° C. | 305° C. | 180° C. |
| 10 V | 90° C. | 230° C. | 140° C. |
| 8 V | 60° C. | 145° C. | 85° C. |

TABLE 3
Heater having resistance wire in 10% of linear part 3 (3-3)

| Applied | Peak Temperature of | Peak Temperature of | Temperature |
|---|---|---|---|
| Voltage | Linear Part 3 | Coil Part 2 | Difference |
| 12 V | 115° C. | 315° C. | 200° C. |
| 10 V | 78° C. | 235° C. | 157° C. |
| 8 V | 53° C. | 148° C. | 95° C. |

It has been found from the above experiment results that the difference in peak temperature between the linear part 3 and the coil part 2 can be controlled by varying the length of the resistance wire in the linear part 3 (in other words, varying the length of the portion without the resistance wire).

In the present experiments, thermal deformation of an outer case (resin case) of the tool of the present application was found when the temperature of the coil part 2 was 250° C. or higher, causing the temperature of the thermal insulation material to rise even outside the thermal insulation material 6. In order to improve this problem, a silver paper or an aluminum foil or the like was attached to the outside of the thermal insulation material 6, by which this problem could be improved.

The fact that the difference in peak temperature between the linear part 3 and the coil part 2 can be controlled means that it is possible to freely set a temperature for preheating of the inserted tobacco leaves, and a temperature of “hot air” for primary heating of the tobacco leaves. The achievement of the present invention has become possible by providing the linear part and the coil part in the heater, and by varying the length of the resistance wire in the linear part.

Regarding how to use the non-combustion smoking tool 100 according to the present invention, it is used in a procedure described below.

1. A smoker inserts its favorite filter cigarette 90 into the tobacco insertion opening 19 of the tool 100 over the entire tobacco portion of the filter cigarette. This allows the linear part 3 of the heater 1 to be inserted into the tobacco portion of the filter cigarette 90.

2. When the smoker supplies power from the connector 10 of the tool of the present application, the indicator 8 lights to indicate that the power is supplied to the heater 1. Further, when the inserted cigarette is preheated to make it possible to inhale, the indicator 8 flashes or changes the emission color. Furthermore, the indicator 8 is designed in a manner that it turns off or changes the emission color when nicotine stops coming out after a certain time, making it possible to inform the smoker that nicotine does not come out with any more inhalation.

3. The smoker inhales through the filter after the tobacco leaves are preheated, so as to allow “hot air” heated by the coil part 2 of the heater 1 to heat the tobacco leaves when passing through the cigarette, thereby vaporizing nicotine. Thus, it is possible to take in nicotine in a state where tar, carbon monoxide and other toxic gases very rarely come out.

Also in the case of normal smoking, the smoker does not inhale continuously, but there is a time between inhalations. Thus, although the heated “hot air” around the coil part 2 of the heater 1 is removed by an inhalation, new air entering through the outside air inlet 25 between the inhalations is heated to produce “hot air” to prepare for the next inhalation.

4. In addition, it is designed to make it possible to increase or decrease power to the heater 1 by a predetermined amount when the smoker turns on the SW 15. Thus, the smoker can finely control the power supplied to the heater 1 while smoking.

5. After that, it is possible to smoke until the indicator 8 turns off or changes the emission color.

Next, improvement points to reduce power consumption of the tool and to develop a battery-operable tool will be described.

Regarding a power supply for the non-combustion smoking tool of the present invention, and considering smoking in a car as well, it is more convenient to set an input voltage to 12V so as to make it possible to use a cigar power supply (12V DC) installed in cars as standard. However, when a battery or a rechargeable battery is used as a power supply, it is required that, with the input voltage of 12V, its current value is designed to be minimized as much as possible.

General current value limiting methods are to insert a current limiting resistor in series with a heater, or insert a power transistor in series with the heater so as to control a current value flowing in the heater, thereby controlling the temperature of the heater. However, these methods have caused the following problems.
These components have large shape, causing the tool to be large.
These components consume power by themselves.
There have been problems such that these components generate heat, so that countermeasures against heat radiation are needed.

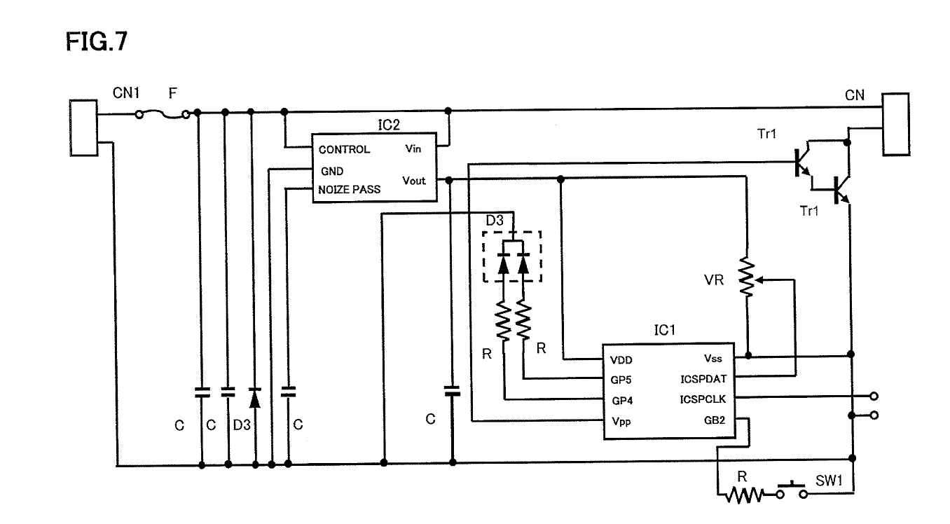

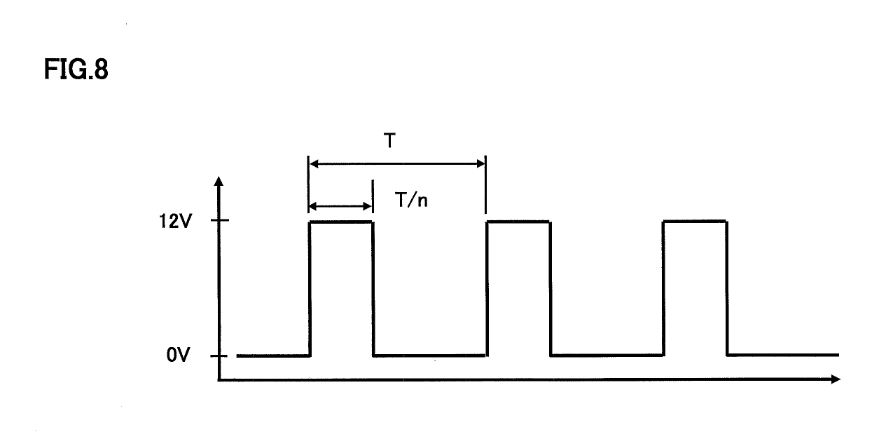

An improved circuit to improve these problems of the conventional technology has been devised. FIG. 7 shows its basic circuit diagram, and FIG. 8 shows an output voltage waveform of this circuit diagram. The circuit configuration will be described below. IC1 is a main component of the present circuit, and called a 4-bit/ 8-bit microcomputer, and has three input and three output ports. IC2 is a circuit called a regulator, which has an input of 12V and is configured to be able to produce an output of 2.5 V to drive the IC1. D1 is formed by a combination of two color emitting diodes, and can display various colors by controlling the emission ratio of the two colors. VR1 is used to make the input to the IC1 variable, enabling the smoker to vary the heater temperature when smoking. SW1 is used to make the input to the IC1 variable, and is used for the smoker to finely control the heater temperature while smoking. IN1 is another input to the IC1, and by attaching e.g. a temperature sensor to its terminal, it is possible that while the peak temperature of the heater is measured, it can be maintained at a constant temperature, and that by detecting its heat, electric power supply to the heater can be stopped. Tr1, Tr2 are elements serving to turn ON and OFF the voltage supplied to the heater 1 in response to a signal from the IC1. F1 is a fuse inserted to protect the present circuit when an excessive voltage is supplied from CN1.

The present circuit has necessary software written in the IC1 in advance so as to control outputs Vpp, GP4 and GP5 according to the software.

FIG. 8 shows an example of a waveform of this circuit. The input voltage of 12V itself is output as an output voltage, in which the control of the peak surface temperature of the heater can be achieved by varying “n” value indicated by T/n in the drawing.

Further, the software in the IC1 is built so that by pressing the SW1, “n” can be varied only while the SW1 is pressed when the voltage waveform shown in FIG. 8 is output.

The novel circuit design has made it possible to obtain the following features.
The control circuit section is reduced.
The power consumption of the control circuit section is reduced.
A user of the tool can freely control the peak temperature of the heater.

Further, various structural items to allow a slender heater 1 to be directly inserted into a commercial cigarette or cigar can be devised from the tool of the present invention, not limited to the structures described above.

### INDUSTRIAL APPLICABILITY

The present invention makes it possible to use a commercial filter cigarette or cigar in the form as it is, and to inhale nicotine contained in the tobacco leaves without burning it, and in addition relates to a tool which has been further improved over the non-combustion smoking tool of Japanese Patent Application No. 2009-049879 filed by the present applicant.

### DESCRIPTION OF THE REFERENCE NUMERALS

1 Heater

2 Linear part of the heater 1

3 Coil part of the heater 1

4 Sleeve of the heater 1

5 Lead of the heater 1

6 Thermal insulation material

7 Component-embedded printed circuit board

8 Indicator

9 Volume

10 Connector

11 Output Transistor

12 CPU

13 Electrolytic capacitor

14 Fuse

15 Switch

19 Insertion opening

20 Projection

21 Section to contain the thermal insulation material

22 Section to hold the sleeve of the heater

23 Section to contain the printed circuit board

24 Section to contain the connector

25 Outside air inlet/Filter insertion portion/Mouthpiece fitting portion

90 Filter cigarette

100 Example of the tool of the present application

110 Mouthpiece

1. A non-combustion smoking tool comprising a heater to be used which has a structure comprising a coil part and a linear part to be inserted into a cigarette or a cigar, wherein the linear part preheats tobacco leaves, and the coil part heats air around the coil part so that, upon inhalation, the heated air around the coil part passes through the tobacco leaves so as to vaporize nicotine from the tobacco leaves and enable inhalation of the nicotine.

2. The non-combustion smoking tool according to claim 1, wherein the heater to be used comprises: the coil part; and the linear part having a heating resistance wire in a range from 95% to 5% of the linear part.

3. The non-combustion smoking tool according to claim 1, which comprises the heater to be used which has the structure comprising the coil part and the linear part to be inserted into the cigarette or the cigar, and further comprises a built-in circuit to enable a smoker to control electric power supply to the heater.

4. (canceled)

5. The non-combustion smoking tool according to claim 1, which comprises a circuit to control electric power supply to the heater by varying on time of ON and OFF voltage supply.

6. A non-combustion smoking tool comprising a heater to be used which has a structure comprising a linear part to be inserted into a cigarette or a cigar, and a built-in circuit to enable a smoker to control electric power supply to the heater, wherein the linear part heats tobacco leaves, so as to vaporize nicotine from the tobacco leaves and enable inhalation of the nicotine.

7. The non-combustion smoking tool according to claim 6, wherein the built-in circuit controls electric power supply to the heater by varying on time of ON and OFF voltage supply.
